(19) United States
(12) Patent Application Publication
(10) Pub. No.: US 2024/0071029 A1
(43) Pub. Date: Feb. 29, 2024

(54) SOFT ANCHOR POINT OBJECT DETECTION

(71) Applicant: CARNEGIE MELLON UNIVERSITY, Pittsburgh, PA (US)

(72) Inventors: Chenchen ZHU, Pittsburgh, PA (US); Marios Savvides, Pittsburgh, PA (US); Zhiqiang Shen, Pittsburgh, PA (US); Fangyi Chen, Pittsburgh, PA (US)

(21) Appl. No.: 18/272,290

(22) PCT Filed: Jan. 24, 2022
(86) PCT No.: PCT/US2022/013485

§ 371 Date: Jul. 13, 2023

Related U.S. Application Data
(60) Provisional application No. 63/145,583, filed on Feb. 4, 2021.

(51) Int. Cl. G06V 10/25; G06V 10/44; G06V 10/74; G06V 10/764

(52) U.S. Cl. CPC G06V 10/25; G06V 10/44; G06V 10/761; G06V 10/764; G06V 2201/07

(57) ABSTRACT

Disclosed herein is a method of soft anchor-point detection (SAPD), which implements a concise, single-stage anchor-point detector with both faster speed and higher accuracy. Also disclosed is a novel training strategy with two softened optimization techniques: soft-weighted anchor points and soft-selected pyramid levels.

### RELATED APPLICATIONS

This application claims the benefit of U.S. Provisional Patent Application No. 63/145,583, filed Feb. 4, 2021, the contents of which are incorporated herein in its entirety.

### BACKGROUND

Anchor-free object detectors are object detectors that are not reliant on anchor boxes. Instead, predictions are generated in a point(s)-to-box style. Compared to conventional anchor-based approaches, anchor-free detectors have several advantages, namely: 1) no manual tuning of hyperparameters for the anchor configuration; 2) usually simpler architecture of detection head; 3) less training memory cost.

Anchor-free detectors can be roughly divided into two categories: anchor-point detection and key-point detection. Anchor-point detectors encode and decode object bounding boxes as anchor points with corresponding point-to-boundary distances, where the anchor points are the pixels on the pyramidal feature maps and they are associated with the features at their locations just like the anchor boxes. Key-point detectors predict the locations of key points of the bounding box (e.g., corners, center, or extreme points), using a high-resolution feature map and repeated bottom-up top-down inference, and group those key points to form a box.

Compared to key-point detectors, anchor-point detectors have several advantages, namely: 1) a simpler network architecture; 2) faster training and inference speed; 3) the potential to benefit from augmentations on feature pyramids; and 4) flexible feature level selection. However, they cannot be as accurate as key-point-based methods under the same image scale of testing.

### SUMMARY

Disclosed herein is a method of soft anchor-point detection (SAPD), which implements a concise, single-stage anchor-point detector with both faster speed and higher accuracy.

The conventional training strategy has two overlooked issues: false attention within each pyramid level and feature selection across all pyramid levels. For anchor points on the same pyramid level, those receiving false attention in training will generate detections with unnecessarily high confidence scores but poor localization during inference, suppressing some anchor points with accurate localization, but with a lower score. This can confuse the post-processing step because high-score detections usually have priority over the low-score detections in non-maximum suppression, resulting in low AP scores at strict IoU thresholds. For anchor points at the same spatial location across different pyramid levels, their associated features are similar but how much they contribute to the network loss is decided without careful consideration. Current methods make the selection based on ad-hoc heuristics like instance scale and usually limited to a single level per instance. This causes a waste of unselected features.

To address these issues, disclosed herein is a novel training strategy with two softened optimization techniques: soft-weighted anchor points and soft-selected pyramid levels. For anchor points on the same pyramid level, the false attention is reduced by reweighting their contributions to the network loss according to their geometrical relation with the instance box. The closer to the instance boundaries, the harder it is for anchor points to localize objects precisely due to feature misalignment and, therefore, the less they should contribute to the network loss. Additionally, an anchor point is further reweighted by the instance-dependent “participation” degree of its pyramid level. A light-weight feature selection network is implemented to learn the per-level “participation” degrees given the object instances. The feature selection network is jointly optimized with the detector and not involved in detector inference.

### BRIEF DESCRIPTION OF THE DRAWINGS

By way of example, a specific exemplary embodiment of the disclosed system and method will now be described, with reference to the accompanying drawings, in which:

FIG. 1 is a block diagram of a network architecture of an anchor-point detector with a simple detection head.

FIG. 2 is a block diagram illustrating a training strategy using soft-weighted anchor points and soft-selected pyramid levels.

FIG. 3(a) shows poorly localized detection boxes.

FIG. 3(b) shows improved localization via soft-weighting.

FIG. 4 shows feature responses from several levels of the feature pyramid.

FIG. 5 is a block diagram showing the weights prediction for soft-selected pyramid levels.

### DETAILED DESCRIPTION

Soft Anchor Point Detector—The details of soft anchor-point detector (SAPD) will now be disclosed. DenseBox was an early anchor-point detector. Recent modern anchor-point detectors modify DenseBox by attaching additional convolution layers to the detection head of DenseBox for multiple levels in the feature pyramids. Herein is introduced the general concept of a representative in terms of network architecture, supervision targets, and loss functions.

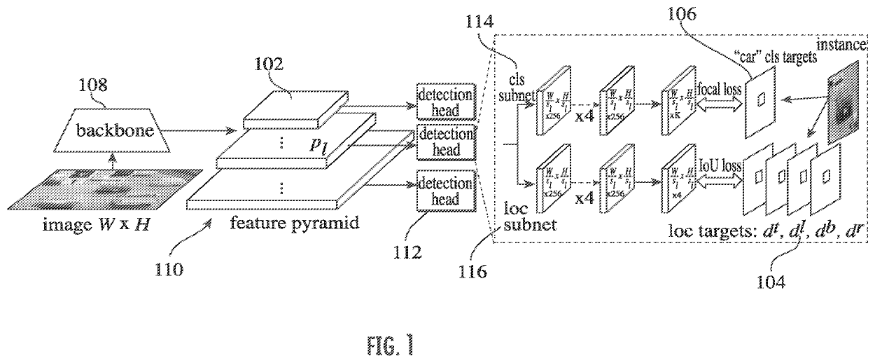

FIG. 1 shows the network architecture of an anchor-point detector using a simple detection head 112. The network consists of a backbone 108, a feature pyramid 110, and one detection head 112 per pyramid level 102, in a fully convolutional style. A pyramid level 102 is denoted as Pₗ where l indicates the level number and it has 1/sₗ resolution of the input image size W×H. sₗ is the feature stride and sₗ=2^{l}. A typical range of l is 3 to 7. A detection head has two task-specific subnets, a classification subnet 114 and a localization subnet 116. In one embodiment, each subnet may comprise, for example, five 3×3 conv layers. The classification subnet predicts the probability of objects at each anchor point location for each of the K object classes. The localization subnet predicts the 4-dimensional class-agnostic distance from each anchor point to the boundaries of a nearby instance if the anchor point is positive (defined below).

An anchor point pₗ_{ᵢⱼ} is a pixel on the pyramid level Pₗ located at (i, j) with i=0, 1, . . . , W/sₗ−1 and j=0, 1, . . . , H/sₗ−1. Each pₗ_{ᵢⱼ} has a corresponding image space location (Xₗ_{ᵢⱼ}, Yₗ_{ᵢⱼ}) where Xₗ_{ᵢⱼ}=sₗ(i+0.5) and Yₗ_{ᵢⱼ}=sₗ(j+0.5). Next, a valid box Bᵥ of a ground-truth instance box B=(c, x, y, w, h) is defined, where c is the class id, (x, y) is the box center, and w, h are box width and height respectively. Bᵥ is a central shrunk box of B (i.e., Bᵥ(c, x, y, ϵw, ϵh)) where ϵ is the shrunk factor. An anchor point pₗ_{ᵢⱼ} is positive if and only if some instance B is assigned to Pₗ and the image space location (Xₗ_{ᵢⱼ}, Yₗ_{ᵢⱼ}) of pₗ_{ᵢⱼ} is inside Bᵥ, otherwise it is a negative anchor point. For a positive anchor point, its classification target is c and localization targets 104 are calculated as the normalized distances d=(d^{l}, d^{t}, d^{r}, d^{b}) from the anchor point to the left, top, right, bottom boundaries of B respectively.

$${d}^{l} = \frac{1}{{zs}_{l}} [ {X}_{{l}_{ij}} - ( x - w {/}_{2} ) ] \qquad ( 1 )$$

$${d}^{t} = \frac{1}{{zs}_{l}} [ {Y}_{{l}_{ij}} - ( y - h {/}_{2} ) ]$$

$${d}^{r} = \frac{1}{{zs}_{l}} [ ( x + w {/}_{2} ) - {X}_{{l}_{ij}} ]$$

$${d}^{b} = \frac{1}{{zs}_{l}} [ ( y + h {/}_{2} ) - {Y}_{{l}_{ij}} ]$$

where z is the normalization scalar.

For negative anchor points, their classification targets 106 are background (c=0), and localization targets 104 are set to null because they don't need to be learned. To this end, a classification target cₗ_{ᵢⱼ} and a localization target dₗ_{ᵢⱼ} for each anchor point pₗ_{ᵢⱼ} are provided. A visualization of the classification targets 106 and the localization targets 104 of one feature level is illustrated in FIG. 1.

Given the architecture and the definition of anchor points, the network generates a K-dimensional classification output ĉₗ_{ᵢⱼ} and a 4-dimensional localization output \hat{d}ₗ_{ᵢⱼ} per anchor point pₗ_{ᵢⱼ} indicative of a predicted location of the detection box for the anchor point. Focal loss (l_{FL}) is adopted for the training of classification subnets to overcome the extreme class imbalance between positive and negative anchor points. IoU loss (l_{IoU}) is used for the training of localization subnets. Therefore, the per anchor point loss Lₗ_{ᵢⱼ} is calculated in accordance with Eq. (2):

$${L}_{{l}_{ij}} = \{ \begin{matrix}{l}_{FL} ( {\hat{c}}_{{l}_{ij}} , {c}_{{l}_{ij}} ) + {l}_{IoU} ( {\hat{d}}_{{l}_{ij}} , {d}_{{l}_{ij}} ) , {p}_{{l}_{ij}} ∈ {p}^{+} \\ {l}_{FL} ( {\hat{c}}_{{l}_{ij}} , {c}_{{l}_{ij}} ) , {p}_{{l}_{ij}} ∈ {p}^{-}\end{matrix} \qquad ( 2 )$$

where p⁺ and p⁻ are the sets of positive and negative anchor points respectively.

The loss for the whole network is the summation of all anchor point losses divided by the number of positive anchor points, as given by Eq. (3):

$$L = \frac{1}{{N}_{{p}^{+}}} {\sum }_{l} {\sum }_{ij} {L}_{{l}_{ij}} \qquad ( 3 )$$

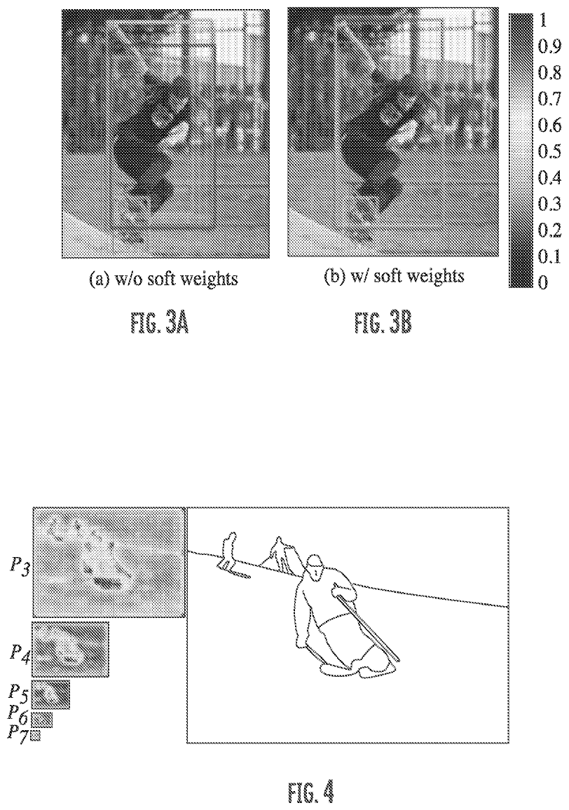

Soft-Weighted Anchor Points—Under the conventional training strategy, during inference some anchor points generate detection boxes with poor localizations but high confidence scores, which suppresses the boxes with more precise localizations but lower scores. As a result, the non-maximum suppression (NMS) tends to keep the poorly localized detections, leading to low AP at a strict IoU threshold. An example of this observation is visualized in FIG. 3(a), which illustrates that poorly localized detection boxes with high scores are generated by anchor points receiving false attention. The detection boxes are plotted before NMS with confidence scores indicated by the color. In this example, the box with a more precise localization of the person is suppressed by other boxes which are not as accurate, but which have high scores. Then the final detection (bold box) after NMS doesn't have high IoU with the ground-truth.

This is because the conventional training strategy treats anchor points independently in Eq. (3) (i.e., they receive equal attention). For a group of anchor points inside Bᵥ, their spatial locations and associated features are different. As such, their abilities to localize B are also different. Anchor points located close to instance boundaries don't have features well aligned with the instance. Their features tend to be hurt by content outside the instance because their receptive fields include too much information from the background, resulting in less representation power for precise localization. Thus, forcing these anchor points to perform as well as those with powerful feature representation tends to mislead the network. Less attention should be paid to anchor points close to instance boundaries than those surrounding the center in training. In other words, the network should focus more on optimizing the anchor points with powerful feature representation and reduce the false attention to others.

To address the false attention issue, the invention provides a simple and effective soft-weighting scheme. The basic idea is to assign an attention weight wₗ_{ᵢⱼ} for each anchor point's loss Lₗ_{ᵢⱼ}. For each positive anchor point, the weight depends on the distance between its image space location and the corresponding boundaries of B. The closer to a boundary, the more down-weighted the anchor point gets. Thus, anchor points close to boundaries receive less attention and the network focuses more on those surrounding the center. For negative anchor points, they are kept unchanged because they are not involved in localization (i.e., their weights are all set to 1). Mathematically, wₗ_{ᵢⱼ} is defined by Eq. (4):

$${w}_{{l}_{ij}} = \{ \begin{matrix}f ( {p}_{{l}_{ij}} , B ) , ∃ B , {p}_{{l}_{ij}} ∈ {B}_{v} \\ 1 , otherwise\end{matrix} \qquad ( 4 )$$

where ƒ is a function reflecting how close pₗ_{ᵢⱼ} is to the boundaries of B.

Closer distance yields less attention weight. ƒ is instantiated using a generalized version of a centerness function, such as:

$$f ( {p}_{{l}_{ij}} , B ) = {[ \frac{min ( {d}_{{l}_{ij}}^{l} , {d}_{{l}_{ij}}^{r} ) min ( {d}_{{l}_{ij}}^{t} , {d}_{{l}_{ij}}^{b} )}{max ( {d}_{{l}_{ij}}^{l} , {d}_{{l}_{ij}}^{r} ) max ( {d}_{{l}_{ij}}^{t} , {d}_{{l}_{ij}}^{b} )} ]}^{η}$$

where η controls the decreasing steepness.

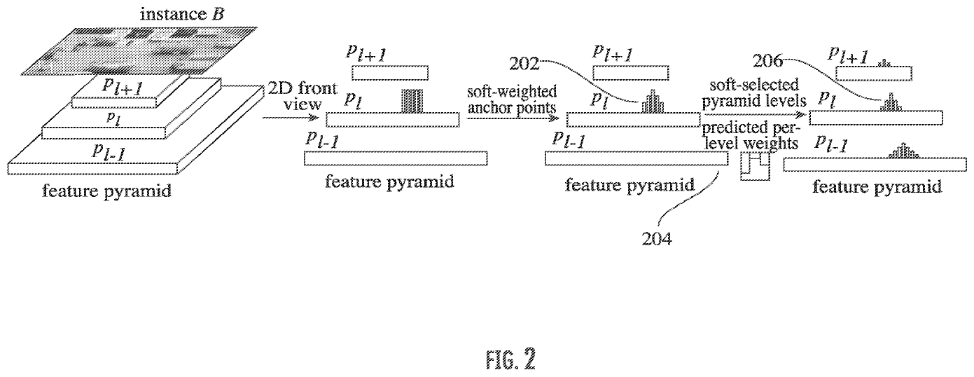

An example of soft-weighted anchor points is shown as reference 202 in FIG. 2. An illustration of the soft-weighted anchor points is shown in FIG. 3(b), which shows that the soft-weighting scheme of the present invention effectively improves localization. The box score is indicated by the color bar on the right.

Soft-Selected Pyramid Levels—Unlike anchor-based detectors, anchor-free methods don't have constraints from anchor matching to select feature levels for instances from the feature pyramid. In other words, each instance can be assigned to arbitrary feature level(s) in anchor-free methods during training. Selecting the right feature levels can make a big difference.

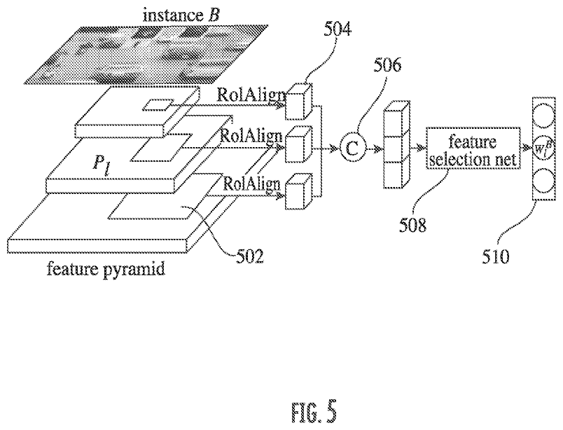

The issue of feature selection is approached by looking into the properties of the feature pyramid. Feature maps from different pyramid levels are somewhat similar to each other, especially the adjacent levels. The response of all pyramid levels is visualized in FIG. 4, which shows feature responses from P₃ to P₇. Note that they look similar, but the details gradually vanish as the resolution becomes smaller. Selecting a single level per instance causes the waste of network power. It turns out that if one level of feature is activated in a certain region, the same regions of adjacent levels may also be activated in a similar style. But the similarity fades as the levels are farther apart. This means that features from more than one pyramid level can participate together in the detection of a particular instance, but the degrees of participation from different levels should be somewhat different.

Thus, there should be two principles for proper pyramid level selection. First, the selection should be related to the pattern of feature response, rather than some ad-hoc heuristics, and the instance-dependent loss can be a good reflection of whether a pyramid level is suitable for detecting some instances. Second, features from multiple levels should be involved in the training and testing for each instance, and each level should make distinct contributions. Assigning instances to multiple feature levels can improve the performance to some extent but assigning to too many levels may hurt the performance severely. This limitation is likely caused by the hard selection of pyramid levels. For each instance, the pyramid levels are either selected or discarded. The selected levels are treated equally no matter how different their feature responses are.

Therefore, the solution lies in reweighting the pyramid levels for each instance. In other words, a weight is assigned to each pyramid level according to the feature response, making the selection soft. This can also be viewed as assigning a proportion of the instance to a level.

To decide the weight of each pyramid level per instance, the invention provides for the training of a feature selection network to predict the weights for soft feature selection, shown schematically as reference 204 in FIG. 2. This is illustrated in FIG. 5. The input to the network is instance-dependent feature responses 502 extracted from all the pyramid levels. In one embodiment, this is realized by applying the RoIAlign layer 504 to each pyramid feature followed by concatenation 506, where the RoIAlign 504 is the instance ground-truth box. Then the extracted feature goes through a feature selection network 508 to output a vector 510 of the probability distribution. The probabilities are used as the weights 204 for the soft feature selection.

There are multiple architecture designs for the feature selection network. In one embodiment, for simplicity, a light-weight instantiation is presented, consisting of three 3×3 conv layers with no padding, each followed by the ReLU function, and a fully-connected layer with softmax. Table 1 details one embodiment of the architecture of the feature selection network.

TABLE 1

| Layer Type | Output Size | Layer Setting | Activation |
|---|---|---|---|
| Input | 1280 × 7 × 7 | n/a | n/a |
| Conv | 256 × 5 × 5 | 3 × 3, 256 | ReLu |
| Conv | 256 × 3 × 3 | 3 × 3, 256 | ReLu |
| Conv | 256 × 1 × 1 | 3 × 3, 256 | ReLu |
| FC | 5 | n/a | SoftMax |

The feature selection network is jointly trained with the detector. Cross entropy loss is used for optimization and the ground-truth is a one-hot vector indicating which pyramid level has minimal loss.

So far, each instance B is associated with a per level weight wₗ^{B} via the feature selection network. Together with previously-described soft-weighting scheme, the anchor point loss Lₗ_{ᵢⱼ} is down-weighed further, as shown by reference 206 in FIG. 2, if B is assigned to Pₗ and pₗ_{ᵢⱼ} is inside Bᵥ. Each instance B is assigned to topk feature levels with k minimal instance-dependent losses during training. Thus, Eq. (4) is augmented into Eq. (5):

$${w}_{{l}_{ij}} = \{ \begin{matrix}{w}_{l}^{B} f ( {p}_{{l}_{ij}} , B ) , ∃ B , {p}_{{l}_{ij}} ∈ {B}_{v} \\ 1 , otherwise\end{matrix} \qquad ( 5 )$$

The total loss of the whole model is the weighted sum of anchor point losses plus the classification loss (L_{select-net}) from the feature selection network, as given by Eq. (6).

$$L = \frac{1}{{\sum }_{{p}_{{l}_{ij} ∈ p} +} {w}_{{l}_{ij}}} {\sum }_{{l}_{ij}} {w}_{{l}_{ij} {L}_{{l}_{ij}} + λ {L}_{select - nnet}} \qquad ( 6 )$$

where λ is the hyperparameter that controls the proportion of classification loss L_{select-net} for feature selection.

FIG. 2 illustrates the training strategy with soft-weighted anchor points and soft-selected pyramid levels. The black bars indicate the assigned weights of positive anchor points, indicating their contribution to the overall network loss. The key insight is the joint optimization of anchor points as a group both within and across feature pyramid levels.

Implementation Details—In one embodiment, the backbone networks are pre-trained on ImageNet1k. The classification layers in the detection head can be initialized with bias −log((1−π)/π), where π=0.01, and a Gaussian weight. The localization layers in the detection head are initialized with bias 0.1, and also a Gaussian weight. For the newly added feature selection network, all layers in it are initialized using a Gaussian weight. All the Gaussian weights are filled with σ=0.01.

The entire detection network and the feature selection network, in one embodiment, are jointly trained with stochastic gradient descent on 8 GPUs with 2 images per GPU using the COCO train2017 set. Unless otherwise noted, all models are trained for 12 epochs (˜90 k iterations) with an initial learning rate of 0.01, which is divided by 10 at the 9th and the 11th epochs. Horizontal image flipping is the only data augmentation unless otherwise specified. For the first 6 epochs, the output from the feature selection network is not used. The detection network is trained with the same online feature selection strategy as in the FSAF module (i.e., each instance is assigned to only one feature level yielding the minimal loss). The soft selection weights are plugged in and the topk levels are chosen for the second 6 epochs. This is to stabilize the feature selection network first and to make the learning smoother in practice. The same training hyper-parameters are used for the shrunk factor ϵ=0.2 and the normalization scalar z=4.0. Lastly, λ=0.1 although results are robust to the exact value.

At the time of inference, the network architecture is as simple as the architecture depicted in FIG. 1. The feature selection network is not involved in the inference, so the runtime speed is not affected. An image is forwarded through the network in a fully convolutional style. Then, classification prediction ĉₗ_{ᵢⱼ} and localization prediction \hat{d}ₗ_{ᵢⱼ} are generated for each anchor point pₗ_{ᵢⱼ}. Bounding boxes can be decoded using the reverse of Eq. (1). Box predictions from at most 1 k top-scoring anchor points in each pyramid level are only decoded after thresholding the confidence scores by 0.05. These top predictions from all feature levels are merged, followed by non-maximum suppression with a threshold of 0.5, yielding the final detections.

The novelty of the invention lies in the joint optimization of a group of anchor points, both within and across the feature pyramid levels. A novel training strategy is disclosed addressing two underexplored issues of anchor-point detection approaches (i.e., the false attention issue within each pyramid level and the feature selection issue across all pyramid levels). Applying the disclosed training strategy to a simple anchor-point detector leads to a new upper envelope of the speed-accuracy trade-off.

As would be realized by one of skill in the art, the methods described herein can be implemented by a system comprising a processor and memory, storing software that, when executed by the processor, performs the functions comprising the method.

1. A method for training an object detector, the object detector comprising:
a backbone;
a feature pyramid coupled to the backbone; and
a detection head coupled to each level of the feature pyramid, each detection head having a classification subnet and a localization subnet; the method comprising:
defining, on a level of the feature pyramid, a ground-truth instance box enclosing an object of interest in a class for which the object detector is being trained;
identifying one or more anchor points within the ground-truth instance box, each anchor point having an associated image space location;
calculating, for each anchor point, a loss indicative of a difference between a box predicted by the anchor point and the ground-truth instance box; and
weighting the loss for each anchor point based on the distance of the anchor point from a boundary of the ground-truth instance box.

2. The method of claim 1 wherein:
the classification subnet predicts a probability of an object of interest at a location for each anchor point; and
the localization subnet predicts a distance from each anchor point to boundaries of the ground-truth instance box.

3. The method of claim 1 wherein losses associated with the anchor points having image space locations closer to a boundary of the ground-truth instance box are down-weighted.

4. The method of claim 3 wherein the closer an image space location of an anchor point to the boundary of the ground-truth instance box, the greater the down-weighting of the loss associated with the anchor point.

5. The method of claim 3 wherein weights are applied only to positive anchor points, wherein positive anchor points have an image space location within a shrunken version of the ground-truth instance box.

6. The method of claim 5 wherein the ground-truth instance box is shrunk based on a shrunk factor.

7. The method of claim 5 wherein negative anchor points have an image space location outside of the shrunken ground-truth instance box.

8. The method of claim 7 wherein negative location points are not considered in localization of the ground-truth instance box.

9. The method of claim 5 wherein the object detector further comprises:
a feature selection network for predicting weights for each layer of the feature pyramid based on instance-dependent feature responses for each level.

10. The method of claim 9 wherein the feature selection network takes as input feature responses extracted from pyramid levels and outputs, for each layer, a probability distribution to be used as the weight for that layer.

11. The method of claim 10 wherein anchor point losses are further down-weighted based on the weight for the layer in which each anchor point is located.

12. The method of claim 11 wherein anchor point losses are further down-weighted if the instance box is assigned to the level in which the image space location of the anchor point is located and further if the anchor point is a positive anchor point.

13. The method of claim 5 wherein a total loss is calculated as a sum of the anchor point weighted losses plus the classification loss.

14. The method of claim 12 wherein a total loss is calculated as a sum of the anchor point weighted losses plus the classification loss.

15. A system comprising:
a processor;
memory, storing software that, when executed by the processor, performs the method of claim 13.

16. A system comprising:
a processor;
memory, storing software that, when executed by the processor, performs the method of claim 14.
